(19) United States
(12) Patent Application Publication
(10) Pub. No.: US 2009/0165015 A1
(43) Pub. Date: Jun. 25, 2009

(54) MANAGING DEPENDENCIES AMONG APPLICATIONS USING SATISFIABILITY ENGINE

(75) Inventor: Anuj Goel, Beijing (CN)

Correspondence Address: HOFFMAN WARNICK LLC, 75 STATE STREET, 14TH FLOOR, ALBANY, NY, 12207, US

(73) Assignee: SCHLUMBERGER TECHNOLOGY CORPORATION, Houston, TX (US)

(21) Appl. No.: 11/962,678

(22) Filed: Dec. 21, 2007

(51) Int. Cl. G06F 9/46

(52) U.S. Cl. 718/106

(57) ABSTRACT

A solution for managing dependencies among multiple applications is disclosed. A method may comprise: receiving dependency information of each application; receiving state information of a first application of the multiple applications; determining a state transition for a second different application of the multiple applications based on the dependency information and the state information; and outputting the determined state transition information to manage the second different application.

### FIELD OF THE INVENTION

The disclosure relates in general to application management, and more particularly to managing dependencies among multiple applications.

### BACKGROUND OF THE INVENTION

In a computer program execution, a list of possible tasks may be presented to a user as options for the sequence of execution. Each of the tasks may have indeterminate or changeable dependencies based upon other task(s). For example, the execution of a task may depend on the state of other tasks, the availability of other tasks, and/or the execution history of other tasks. In addition, the dependency of a task upon another task may depend on a third task. For example, task A may depend on task B only if task C is executed successfully. The multiple tasks may include different application specific formats for data storage, data processing, execution, and data communication, etc., such that the state change of a given task may not be efficiently monitored and/or processed to manage the execution of other tasks that depend on the given task.

### SUMMARY OF THE INVENTION

A first aspect of the invention is directed to a method for managing dependencies among multiple applications, the method comprising: receiving dependency information of each application; receiving state information of a first application of the multiple applications; determining a state transition for a second different application of the multiple applications based on the dependency information and the state information; and outputting the determined state transition information to manage the second different application.

A second aspect of the invention is directed to a system for managing dependencies among multiple applications, the system comprising: means for receiving dependency information of each application and for receiving state information of a first application of the multiple applications; means for determining a state transition for a second different application of the multiple applications based on the dependency information and the state information; and means for outputting the determined state transition information to manage the second different application.

A third aspect of the invention is directed to a computer program product for managing dependencies among multiple applications, comprising: computer usable program code stored on a computer usable medium which, when executed by a computer system, enables the computer system to: receive dependency information of each application; receive state information of a first application of the multiple applications; determine a state transition for a second different application of the multiple applications based on the dependency information and the state information; and output the determined state transition information to manage the second different application.

A fourth aspect of the invention is directed to a method of providing a system for managing dependencies among multiple applications, the method comprising: at least one of: creating, maintaining, deploying or supporting a computer infrastructure operable to: receive dependency information of each application; receive state information of a first application of the multiple applications; determine a state transition for a second different application of the multiple applications based on the dependency information and the state information; and output the determined state transition information to manage the second different application.

Other aspects and features of the present invention, as solely defined by the claims, and additional advantages of the invention will become apparent to those skilled in the art upon reference to the following non-limited detailed description taken in conjunction with the provided figures.

### BRIEF DESCRIPTION OF THE DRAWINGS

The disclosure is illustrated by way of example and not intended to be limited by the figures of the accompanying drawings in which like references indicate similar elements and in which:

FIG. 1 shows a block diagram of a system.

FIG. 2 shows a flow diagram of the operation of a processing center.

FIG. 3 shows a portion of an illustrative example of an interdependency structure.

It is noted that the drawings are not to scale.

### DETAILED DESCRIPTION OF THE DISCLOSURE

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

### 1. SYSTEM OVERVIEW

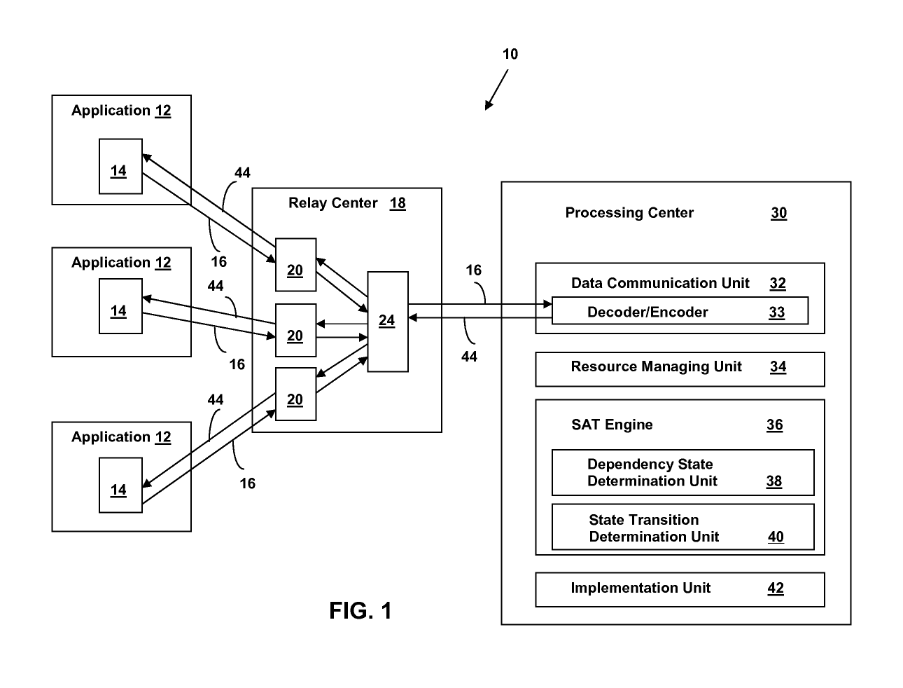

Referring to FIG. 1, a block diagram of an illustrative system 10 for managing dependencies among multiple applications 12 is shown. The term “application” refers to any task, action, conduct, performance, etc. that can be manually or automatically executed. An application 12 may include an application specific interface (“interface”) 14, e.g., an application programming interface (API), that may define the communication of a message 16 of the application 12 in an application specific format. Messages 16 may include any information regarding application 12, e.g., dependency information and/or state (status) information of application 12, e.g., execution state, availability, execution history, etc. In this disclosure “dependency information” of a given application 12 represents the dependent relationship of the given application 12 with respect to other application(s) 12, i.e., which application(s) 12, if any, is dependent on the given application 12, and/or upon which application(s) 12, if any, the given application 12 is dependent. “State information” refers to any information related to the operation states of an application 12, as is further described herein.

Message 16 may be first communicated to a relay center 18, which includes format converters 20 for each application specific format, and an encoder/decoder 24. It should be appreciated that FIG. 1 shows only one relay center 18 including multiple format converters 20 for illustrative purposes only. There may be multiple relay centers 18, each of which being functionally attached to an application 12. In addition, it is possible that different messages 16 from a same application 12 are of different formats. For example, dependency information and state information of an application 12 may be communicated in different formats and may require different format conversion (or by different format converter(s) 20). Moreover, a message 16 may not need to go through relay center 18 and/or format converter 20 in the case that, for example, the application specific format is acceptable by processing center 30. FIG. 1 shows that relay center 18 is separate from applications 12, which is not necessary. Relay center 18 may be located at the same physical location as one or more applications 12. Further relay center 18 may also be located at the same physical location as processing center 30.

Relay center 18 forwards messages 16 to processing center 30. Processing center 30 includes a data communication unit 32 including an decoder/encoder 33, a resource managing unit 34, a satisfiability (SAT) engine 36 including a dependency state determination unit 38 and a state transition determination unit 40; and an implementation unit 42.

According to an embodiment, processing center 30 and/or relay center 18 may be implemented by a computer system. The computer system can comprise any general purpose computing article of manufacture capable of executing computer program code installed thereon to perform the process described herein. The computer system can also comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. The operation of system 10 including relay center 18 and processing center 30 is described herein in detail.

### 2. OPERATION METHODOLOGY

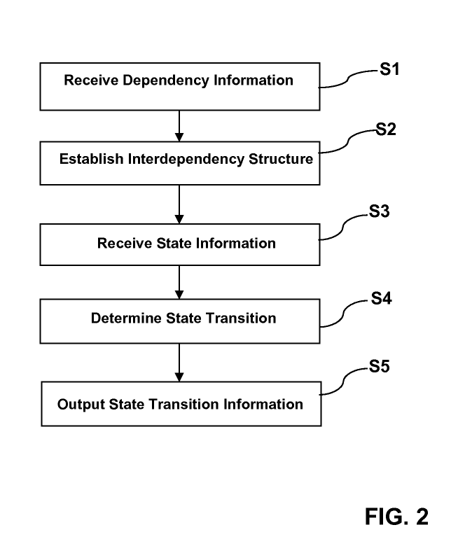

FIG. 2 shows embodiments of the operation of system 10 and processing center 30. Referring to FIGS. 1-2, collectively, in process S1, each application 12 provides the respective dependency information to processing center 30, specifically, resource managing unit 34. If the application specific format of an application 12 is not acceptable to processing center 30, the respective format converter 20 may convert the format of message 16 into a standard format to be used by processing center 30 in, e.g., establishing interdependent relationships between and among applications 12, determining a dependency state of an application 12, and determining a state transition of an application 12, as described herein. According to an embodiment, the dependency information (contained in message 16) of each application 12 may be converted into a First-Order Predicate Logic statement format that processing center 30 uses.

According to an embodiment, encoder/decoder 24 of relay center 18 may further convert (encode) the dependency information in the First-Order Predicate Logic statement format into a transmission format to facilitate the communication of messages 16 between relay center 18 and processing center 30. The transmission format and the encoding may be implemented by any solution. A “solution” generally refers to any now known or later developed approach to achieve a desirable end. For example, the following exemplary code illustrates the conversion of a First-Order Predicate Logic statement into a XML transmission format:

```
        Dependency Statement: TaskA has the following dependency:
!(TaskB.State == TASK_RUNNING) && (TaskC.State ==
TASK_STARTING)
        (In English: TaskA depends on TaskB not being in the
RUNNING state and onTaskC being in the STARTING state).
        Transmission Translation (in XML Format):
<TDNode>
  <DependencyType>COMPLEX_NODE</DependencyType>
  <Operator>BINARY_AND</Operator>
  <TDNode>
    <DependencyType>COMPLEX_NODE</DependencyType>
    <Operator>UNARY_NOT</Operator>
    <TDNode>
      <DependencyType>SIMPLE_NODE</DependencyType>
      <Operator>BINARY_EQUAL</Operator>
      <ComparisonValue>TASK_RUNNING</ComparisonValue>
      <TaskProperty>STATE</TaskProperty>
      <TaskReference>
        <TaskIdentifier>*UniqueComputerGeneratedID*
        </TaskIdentifier>
        <InstanceID></InstanceID>
        <Name>TaskB</Name>
      </TaskReference>
    </TDNode>
  </TDNode>
  <TDNode>
    <DependencyType>SIMPLE_NODE</DependencyType>
    <Operator>BINARY_EQUAL</Operator>
    <ComparisonValue>TASK_STARTING</ComparisonValue>
    <TaskProperty>STATE</TaskProperty>
    <TaskReference>
      <TaskIdentifier>*UniqueComputerGeneratedID*</TaskIdentifier>
      <InstanceID></InstanceID>
      <Name>TaskC</Name>
    </TaskReference>
  </TDNode>
</TDNode>
```

Note that in the XML code provided, the translation preserves the structure of the logic statement for much more complicated statements. The value called “*UniqueComputerGeneratedID*” is a computer specific ID assigned to the Task (application 12) as an identifier. It has been abstracted to preserve the readability of the example. The field called “InstanceID” is initially blank when the First Order Logic is converted into the transmission format. After the transmission format is turned back into FirstOrderLogic, the “InstanceID” field is filled in with a reference to an actual instance of the Task that exists in the system (using the “TaskReference” field as a guide for finding it).

Upon receipt of the dependency information in the transmission format, decoder/encoder 33 of data communication unit 32 converts (decodes) the transmission format back into the First-Order Predicate Logic statement format to be used by resource managing unit 34.

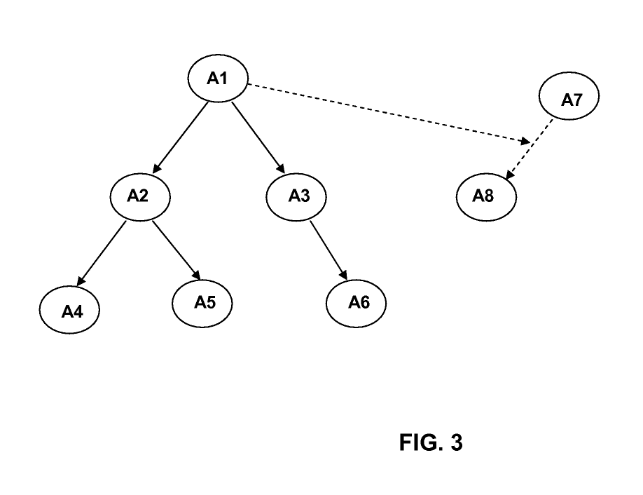

In process S2, resource managing unit 34 establishes an interdependency structure between and among multiple applications 12 based on the received dependency information (message 16). The interdependency structure may be an interrelated tree-like (hierarchical) structure as illustratively shown in FIG. 3 with a lower level node depending on a related (represented by the solid arrow) higher level node. As shown in FIG. 3, the direction of an arrow represents the dependence relationship between two nodes, e.g., application A2 is dependent upon application A1. Between two applications (nodes) with a dependence link, e.g., from A1 to A2, the application (A2) that depends on the other application (A1) will be referred to as a “dependent” application, and the other application (A1) will be referred to as a “condition” application, for descriptive purposes only. FIG. 3 also shows that the dependency of an application (node) A8 upon another application (node) A7 is dependent/conditioned on a third application (node) A1 (dotted arrow being used to represent the conditional dependency link).

It should be appreciated that the dependency link (arrow) in FIG. 3 just illustratively represents the existence of a dependent relationship between two applications 12. In the interdependency structure, the details of the dependent relationship, e.g., which state of application A1 defines/conditions the execution of application A2, are also included. In addition, the dependent relationships may be categorized into different categories. For example, dependent relationships may include mandatory dependency and recommended dependency, the latter of which may be overcome by a user demand, e.g., a demand to run an application 12 even if the recommended dependency is still evaluated to be false (condition unsatisfied). The established interdependency structure may be stored in a database in a manner that facilitates retrieval and updating.

In process S3, data communication unit 32 receives state information of applications 12. State information may include any information related to the operation states of an application 12. Table 1 provides examples of the states of application 12:

TABLE 1
Examples of States

```
Inactive (application inactive for execution):
        Blocked: Mandatory unsatisfied
        Demandable: recommended dependency unsatisfied, executable
                    by demand
        Runnable: All dependency satisfied, ready to run
Active (application active for execution):
        Starting
        Running
        Stopping
        Aborting
Exited (execution exited):
        Passed
        Warned
        Failed
        Aborted
```

According to an embodiment, the providing and receiving of state information may be implemented in substantially real time to/by processing center 30. In addition, the state information message (16) may be format converted similar to the dependency information as described in process S1. The received state information may be provided to/retrieved by SAT engine 36 for further operation. According to an embodiment, SAT engine 36 may instruct on what state information is required. For example, in the case that initial state information or the last update of state information of applications 12 is already stored in processing center 30, SAT engine may only demand state information from applications 12 which have experienced state transitions (state changes) since the last state information update/report.

In process S4, SAT engine 36 determines a state transition for an application 12 based on the dependency information of applications 12 and the received state information. A “state transition” refers to a change in the state of an application 12. The state transition determination includes determining whether or not an application 12 is ready to change the state thereof and how the application 12 changes the state. According to an embodiment, based on the state information and the interdependency structure established in process S2, dependency state determination unit 38 calculates in substantially real time the dependency state of an application 12. A “dependency state” of an application 12 refers to upon which condition application(s) 12 the application 12 is currently dependent and whether the condition(s) has been satisfied (evaluated to be true).

Based on the determined dependency state, state transition determination unit 40 further determines whether the application 12 is ready for a state transition, i.e., change of operation state. As described above, according to an embodiment, SAT engine 36 may operate under the First-Order Predicate Logic.

In addition, according to an embodiment, SAT engine 36 determines the state transition of application 12 only with respect to the interdependencies among multiple applications 12. As such, the determining of the state transition of a specific application 12 is always based on the state information of another (different) application 12. To this extent, if an application 12 can change the state (state transition) without checking the state of another application 12, SAT engine 36 may not need to be involved.

In process S5, implementation unit 42 outputs the determined state transition information to manage the operation of the respective application 12. The output message 44 may be communicated to a local user of the application 12 or may be communicated to the application 12 directly. In either case, format conversions may need to be conducted in a reverse direction as that described in processes S1 or S3. That is, output message 44 may need to be converted from a standard format (e.g., First-Order Predicate Logic statement format) to a transmission format to transmit to relay center 18, where output message 44 may be converted back to the standard format and then to application specific format of each respective application 12. In addition, the updated states of applications 12 including the currently determined state transitions may be saved in processing center 30 for further reference, as described herein.

### 3. CONCLUSION

While shown and described herein as a method and system for managing dependencies among multiple applications, it is understood that the invention further provides various additional features. For example, in an embodiment, the invention provides a program product stored on a computer-readable medium, which when executed, enables a computer infrastructure to manage dependencies among multiple applications. To this extent, the computer-readable medium includes program code, such as processing center 30 and/or relay center 18 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory and/or other storage system, and/or as a data signal traveling over a network (e.g., during a wired/wireless electronic distribution of the program product).

In addition, a method of providing a system for managing dependencies among multiple applications can be included. In this case, a computer infrastructure, such as process center 30 and/or relay center 18 (FIG. 1), can be obtained (e.g., created, maintained, deploying, having been made available to, supported, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as process center 30 and/or relay center 18 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the disclosure has been particularly shown and described with reference to exemplary embodiments thereof, it will be understood by those of ordinary skilled in the art that various changes in form and details may be made therein without departing from the spirit and scope of the present invention as defined by the claims. In addition, those of ordinary skill in the art appreciate that any arrangement which is calculated to achieve the same purpose may be substituted for the specific embodiments shown and that the invention has other applications in other environments.

We claim:

1. A method for managing dependencies among multiple applications, the method comprising:
receiving dependency information of each application;
receiving state information of a first application of the multiple applications;
determining a state transition for a second different application of the multiple applications based on the dependency information and the state information; and
outputting the determined state transition information to manage the second different application.

2. The method of claim 1, further comprising converting the dependency information of each application from an application specific format into a standard format for the state transition determination.

3. The method of claim 2, further comprising converting the standard format into a transmission format for transmitting the dependency information to means for receiving the dependency information.

4. The method of claim 2, wherein the standard format includes a First-Order Predicate Logic statement format.

5. The method of claim 1, wherein the state information receiving and the state transition determining are each implemented in substantially real time.

6. The method of claim 1, further comprising establishing an interdependency network between and among the multiple applications based on the received dependency information.

7. A system for managing dependencies among multiple applications, the system comprising:
means for receiving dependency information of each application and for receiving state information of a first application of the multiple applications;
means for determining a state transition for a second different application of the multiple applications based on the dependency information and the state information; and
means for outputting the determined state transition information to manage the second different application.

8. The system of claim 7, further comprising means for converting the dependency information of each application from an application specific format into a standard format for the state transition determination.

9. The system of claim 8, further comprising:
means for converting the standard format into a transmission format for transmitting the dependency information to the receiving means; and
means for converting the transmission formation back to the standard format when the dependency information is received by the receiving means.

10. The system of claim 8, wherein the standard format includes a First-Order Predicate Logic statement format.

11. The system of claim 7, wherein the state information receiving and the state transition determining are each implemented in substantially real time.

12. The system of claim 7, further comprising means for establishing an interdependency network between and among the multiple applications based on the received dependency information.

13. A computer program product for managing dependencies among multiple applications, comprising:
computer usable program code stored on a computer usable medium which, when executed by a computer system, enables the computer system to:
receive dependency information of each application;
receive state information of a first application of the multiple applications;
determine a state transition for a second different application of the multiple applications based on the dependency information and the state information; and
output the determined state transition information to manage the second different application.

14. The program product of claim 13, wherein the program code is further configured to enable the computer system to convert the dependency information of each application from an application specific format into a standard format for the state transition determination.

15. The program product of claim 14, wherein the program code is further configured to enable the computer system to:
convert the standard format into a transmission format for transmitting the dependency information to means for receiving the dependency information; and
convert the transmission formation back to the standard format when the dependency information is received by the receiving means.

16. The program product of claim 14, wherein the standard format includes a First-Order Predicate Logic statement format.

17. The program product of claim 13, wherein the state information receiving and the state transition determining are each implemented in substantially real time.

18. The program product of claim 13, wherein the program code is further configured to enable the computer system to build an interdependency network between and among the multiple applications based on the received dependency information.

19. A method of providing a system for managing dependencies among multiple applications, the method comprising:
at least one of: creating, maintaining, deploying or supporting a computer infrastructure operable to:
receive dependency information of each application;
receive state information of a first application of the multiple applications;
determine a state transition for a second different application of the multiple applications based on the dependency information and the state information; and
output the determined state transition information to manage the second different application.

20. The method of claim 19, wherein the computer infrastructure is further operable to:
convert the dependency information of each application from an application specific format into a standard format for the state transition determination;
convert the standard format into a transmission format for transmitting the dependency information to means for receiving the dependency information; and
convert the transmission formation back to the standard format when the dependency information is received by the receiving means.
